(19) United States
(12) Patent Application Publication
(10) Pub. No.: US 2025/0085462 A1
(43) Pub. Date: Mar. 13, 2025

(54) OPTICAL FILTER, METHOD OF MANUFACTURING OPTICAL FILTER, METHOD OF DESIGNING, DESIGN APPARATUS, AND NON-TRANSITORY COMPUTER-READABLE RECORDING MEDIUM

(71) Applicants: Sumitomo Electric Industries, Ltd., Osaka (JP); National University Corporation Hokkaido University, Sapporo-shi (JP)

(72) Inventors: Tsutomu ISHIKAWA, Osaka-shi (JP); Naoki FUJIWARA, Osaka-shi (JP); Takanori SATO, Sapporo-shi (JP); Kunimasa SAITOH, Sapporo-shi (JP)

(73) Assignees: Sumitomo Electric Industries, Ltd., Osaka (JP); National University Corporation Hokkaido University, Sapporo-shi (JP)

(21) Appl. No.: 18/810,979

(22) Filed: Aug. 21, 2024

(30) Foreign Application Priority Data
Sep. 11, 2023 (JP) 2023-146856

(51) Int. Cl. G02B 5/28; G02B 27/00

(52) U.S. Cl. CPC G02B 5/28; G02B 27/0012

(57) ABSTRACT

A method of manufacturing an optical filter is a method of manufacturing an optical filter including two or more waveguides having four or more sections in which a number of modes of light propagating through the four or more sections is two or more. The method includes designing lengths of the four or more sections, and forming the two or more waveguides based on the lengths of the four or more sections. The designing includes designing the lengths of the four or more sections based on differentiation of propagation constants of the sections with respect to a temperature and widths of the sections.

### CROSS REFERENCE TO RELATED APPLICATIONS

This application claims priority based on Japanese Patent Application No. 2023-146856 filed on Sep. 11, 2023, and the entire contents of the Japanese patent application are incorporated herein by reference.

### TECHNICAL FIELD

The present disclosure relates to an optical filter, a method of manufacturing an optical filter, a method of designing, a design apparatus, and a non-transitory computer-readable recording medium.

### BACKGROUND

Silicon photonics in which an optical element is formed in silicon has been attracting attention. For example, a Mach-Zehnder interferometer may be formed in a silicon layer of a silicon on insulator (SOI) substrate. A TE0 mode light and a TE1 mode light are separately propagated through a plurality of waveguides of the Mach-Zehnder interferometer. Lengths, widths, and the like of the waveguides are adjusted based on the mode, thereby reducing the temperature dependency of a spectrum (Non-Patent Document 1: “Broadband CMOS-compatible SOI temperature insensitive Mach-Zehnder interferometer” Peng Xing and Jaime Viegas OPTICS EXPRESS Vol. 23, No. 19 pp. 24098-24107 (2015)). Polarization rotator-splitters are provided in silicon waveguides to convert the mode of light (Non-Patent Document 2: “Polarization rotator-splitters in standard active silicon photonics platforms” Wesley D. Sacher et al. OPTICS EXPRESS Vol. 22, No. 4 pp. 3777 to 3786 (2014)).

### SUMMARY

A method of manufacturing an optical filter according to the present disclosure is a method of manufacturing an optical filter including two or more waveguides having four or more sections in which there are two or more modes of light propagating through the four or more sections. The method includes designing lengths of the four or more sections, and forming the two or more waveguides based on the lengths of the four or more sections. The designing includes designing the lengths of the four or more sections based on differentiations of propagation constants of the sections with respect to a temperature and widths of the sections.

### BRIEF DESCRIPTION OF THE DRAWINGS

FIG. 1 is a schematic diagram illustrating an optical filter according to a first embodiment.

FIG. 2 is a cross-sectional view illustrating the optical filter.

FIG. 3A is a block diagram illustrating a design apparatus for the optical filter.

FIG. 3B is a block diagram illustrating a hardware configuration of a control device.

FIG. 4A is a flowchart illustrating a method of manufacturing an optical filter.

FIG. 4B is a flowchart illustrating a method of manufacturing the optical filter.

FIG. 5A is a cross-sectional view illustrating a method of manufacturing the optical filter.

FIG. 5B is a cross-sectional view illustrating a method of manufacturing the optical filter.

FIG. 6 is a schematic diagram illustrating an optical filter according to a comparative example.

FIG. 7A is a diagram illustrating a spectrum in the comparative example.

FIG. 7B is a diagram illustrating a spectrum in the comparative example.

FIG. 7C is a diagram illustrating a spectrum in the comparative example.

FIG. 7D is a diagram illustrating a shift amount in a comparative example.

FIG. 8A is a diagram illustrating a spectrum in the first embodiment.

FIG. 8B is a diagram illustrating a spectrum in the first embodiment.

FIG. 8C is a diagram illustrating a spectrum in the first embodiment.

FIG. 8D is a diagram illustrating a shift amount in the first embodiment.

FIG. 9A is a diagram illustrating a spectrum in the first embodiment.

FIG. 9B is a diagram illustrating a spectrum in the first embodiment.

FIG. 9C is a diagram illustrating a spectrum in the first embodiment.

FIG. 9D is a diagram illustrating the shift amount.

FIG. 10 is a plan view illustrating an optical filter according to a second embodiment.

FIG. 11 is a plan view illustrating an optical filter according to a third embodiment.

### DETAILED DESCRIPTION

The length of the waveguide can be designed so that the temperature dependency of characteristics is reduced by the equation (9) of Non-Patent Document 1. For example, the waveguide is formed by etching silicon. However, there is an error occurred in the width of the waveguide. The change in the width of the waveguide increases the temperature dependency of characteristics. Thus, it is an object to provide an optical filter, a method of manufacturing an optical filter, a method of designing, a design apparatus, and a non-transitory computer-readable recording medium that can improve a tolerance.

### DESCRIPTION OF EMBODIMENTS OF PRESENT DISCLOSURE

First, the contents of embodiments according to the present disclosure will be listed and described.
(1) A method of manufacturing an optical filter according to one aspect of the present disclosure is a method of manufacturing an optical filter including two or more waveguides having four or more sections in which a number of two or more modes of light propagating through the four or more sections is two or more. The method includes designing lengths of the four or more sections, and forming the two or more waveguides based on the lengths of the four or more sections. The designing includes designing the lengths of the four or more sections based on differentiations of propagation constants of the sections with respect to a temperature and widths of the sections. The tolerance can be improved by setting the section lengths to appropriate sizes.
(2) In the above (1), the designing the lengths of the four or more sections may include designing the lengths of the four or more sections based on Equation 1.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad [ Equation 1 ]$$

where
L1 to Ln each denote a length of section,
β1 to βn each denote a propagation constant of section,
T denotes a temperature,
λ denotes a wavelength,
k denotes a wave number,
FSR denotes an interval between peaks of spectrum, and
w denotes a width of section.

The tolerance can be improved by setting the section lengths to appropriate sizes.
(3) In the above (1) or (2), the four or more sections may include a first section, a second section, a third section, and a fourth section. The designing the lengths of the four or more sections may be designing a length of the first section, a length of the second section, a length of the third section, and a length of the fourth section. The tolerance can be improved by setting the four section lengths to appropriate sizes.
(4) A method of designing an optical filter is a method of designing an optical filter including two or more waveguides having four or more sections in which a number of modes of light propagating through the four or more sections is two or more. The method includes designing lengths of the four or more sections based on differentiations of propagation constants of the sections with respect to a temperature and widths of the sections. The tolerance can be improved by setting the section lengths to appropriate sizes.
(5) In the above (4), the designing the lengths of the four or more sections may include designing the lengths of the four or more sections based on Equation 1.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad [ Equation 1 ]$$

where
L1 to Ln each denote a length of section,
β1 to βn each denote a propagation constant of section,
T denotes a temperature,
λ denotes a wavelength,
k denotes a wave number,
FSR denotes an interval between peaks of spectrum, and
w denotes a width of section.

The tolerance can be improved by setting the section lengths to appropriate sizes.
(6) In the above (4) or (5), the four or more sections may include a first section, a second section, a third section, and a fourth section. The designing the lengths of the four or more sections may be designing a length of the first section, a length of the second section, a length of the third section, and a length of the fourth section. The tolerance can be improved by setting the four section lengths to appropriate sizes.
(7) A design apparatus for designing an optical filter is a design apparatus for designing an optical filter including two or more waveguides having four or more sections in which a number of modes of light propagating through the four or more sections is two or more. The design apparatus includes a designer that designs lengths of the four or more sections based on differentiations of propagation constants of the sections with respect to a temperature and widths of the sections. The tolerance can be improved by setting the section lengths to appropriate sizes.
(8) In the above (7), the designing the lengths of the four or more sections may include designing the lengths of the four or more sections based on Equation 1.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad [ Equation 1 ]$$

where
L1 to Ln each denote a length of section,
β1 to βn each denote a propagation constant of section,
T denotes a temperature,
λ denotes a wavelength,
k denotes a wave number,
FSR denotes an interval between peaks of spectrum, and
w denotes a width of section.

The tolerance can be improved by setting the section lengths to appropriate sizes.
(9) In the above (7) or (8), the four or more sections may include a first section, a second section, a third section, and a fourth section. The designing the lengths of the four or more sections may be designing a length of the first section, a length of the second section, a length of the third section, and a length of the fourth section. The tolerance can be improved by setting the four section lengths to appropriate sizes.
(10) A non-transitory computer-readable recording medium is a non-transitory computer-readable recording medium storing having stored therein a program executable by for causing a computer for designing an optical filter to execute a process. The optical filter includes two or more waveguides having four or more sections in which a number of two or more modes of light propagating through the four or more sections is two or more. The process includes designing lengths of the four or more sections based on differentiations of propagation constants of the sections with respect to a temperature and widths of the sections. The tolerance can be improved by setting the section lengths to appropriate sizes.
(11) In the above (10), the designing the lengths of the four or more sections may include designing the lengths of the four or more sections based on Equation 1.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad [ Equation 1 ]$$

where
L1 to Ln each denote a length of section,
β1 to βn each denote a propagation constant of section,
T denotes a temperature,
λ denotes a wavelength,
k denotes a wave number,
FSR denotes an interval between peaks of spectrum, and
w denotes a width of section.

The tolerance can be improved by setting the section lengths to appropriate sizes.
(12) In the above (10) or (11), the four or more sections may include a first section, a second section, a third section, and a fourth section. The designing the lengths of the four or more sections may be designing a length of the first section, a length of the second section, a length of the third section, and a length of the fourth section. The tolerance can be improved by setting the four section lengths to appropriate sizes.
(13) An optical filter includes two or more waveguides and four or more sections provided in the two or more waveguides. In the optical filter, at least two or more modes of light propagate through the four or more sections. The tolerance can be improved by setting the section lengths to appropriate sizes.

### Details of Embodiments of Present Disclosure

Specific examples of an optical filter, a method of manufacturing an optical filter, a method of designing, a design apparatus, and a non-transitory computer-readable recording medium according to embodiments of the present disclosure will be described below with reference to the drawings. The present disclosure is not limited to these examples, but is defined by the scope of the claims, and is intended to include all modifications within the meaning and scope equivalent to the scope of the claims.

### First Embodiment

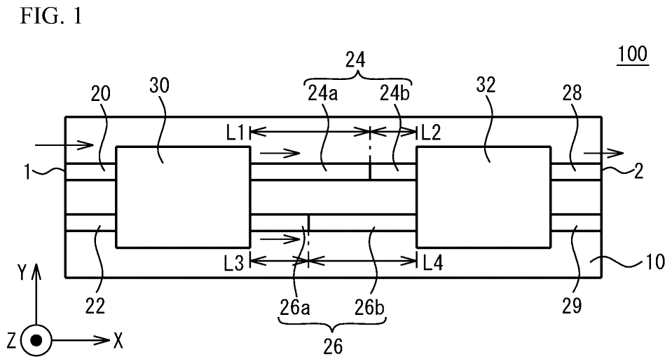

FIG. 1 is a schematic diagram illustrating an optical filter 100 according to a first embodiment. Optical filter 100 is a Mach-Zehnder interferometer filter and is formed in a substrate 10. Substrate 10 is, for example, a silicon on insulator (SOI) substrate. The two sides of substrate 10 are parallel to an X-axis direction. The other two sides are parallel to a Y-axis direction. The upper surface of substrate 10 is parallel to an X-Y plane. A Z-axis direction is a normal direction of substrate 10. The X-axis direction, the Y-axis direction, and the Z-axis direction are orthogonal to each other.

Optical filter 100 includes a waveguide 20, a waveguide 22, a waveguide 24, a waveguide 26, a waveguide 28, a waveguide 29, a coupler 30, and a coupler 32. The waveguides and the couplers are provided in substrate 10.

Coupler 30 and coupler 32 are 3-dB couplers with two-input-two-output, and are directional couplers or the like.

Waveguide 20 has an entry port 1. Waveguide 28 has an exit port 2. Entry port 1 is located at one end of substrate 10. Exit port 2 is located at the other end of substrate 10. The arrows in FIG. 1 represent light propagating through optical filter 100. The light incident on entry port 1 is demultiplexed into a plurality of waveguides, propagates, multiplexed, and emitted from exit port 2. A front side of the waveguide is closer to entry port 1, and a behind side thereof is closer to exit port 2 than the front side.

Waveguide 20 and waveguide 22 extend from one end of substrate 10 in parallel to the X-axis. Waveguide 20 and waveguide 22 are optically coupled to an input end of coupler 30. Waveguide 24 and waveguide 26 are provided between coupler 30 and coupler 32, and are optically coupled to an output end of coupler 30 and an input end of coupler 32. Waveguide 28 and waveguide 29 are optically coupled to an output end of coupler 32 and extend to the other end of substrate 10.

Optical filter 100 has four sections. Waveguide 24 has a section 24a and a section 24b. Section 24a and section 24b are disposed in this order between coupler 30 and coupler 32. Section 24a is coupled to coupler 30. Section 24b is coupled to coupler 32. Waveguide 26 has a section 26a and a section 26b. Section 26a and section 26b are disposed in this order between coupler 30 and coupler 32. Section 26a is coupled to coupler 30. Section 26b is coupled to coupler 32. One waveguide may include a plurality of sections. One waveguide may function as one section.

A length of section 24a is denoted as L1. A length of section 24b is denoted as L2. A length of section 26a is denoted as L3. A length of section 26b is denoted as L4. In the design described below, the lengths of the sections are designed.

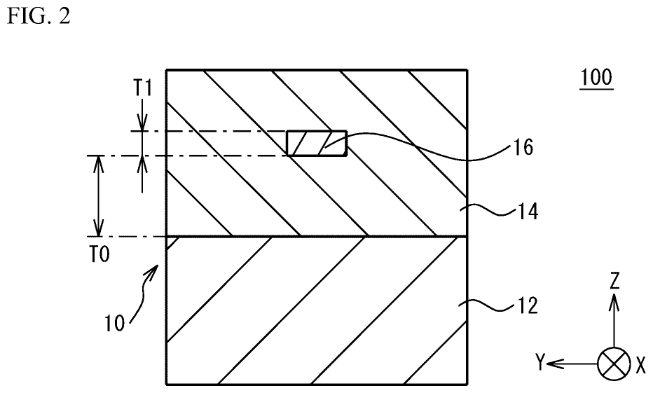

FIG. 2 is a cross-sectional view illustrating optical filter 100, and illustrates a cross-section including one waveguide. Substrate 10 includes a substrate 12, a box layer 14, and a waveguide core 16. Substrate 12 and waveguide core 16 are formed of silicon (Si). Box layer 14 is formed of an insulating material such as silicon oxide (SiO₂). Box layer 14 is stacked on one surface of substrate 12. Waveguide core 16 is embedded in box layer 14 and functions as a waveguide. Waveguide core 16 is a part of a silicon layer. The silicon layer includes a terrace (not illustrated). Waveguide core 16 is spaced apart from the terrace. A thickness Tl of waveguide core 16 is, for example, 220 nm. A distance TO between substrate 12 and waveguide core 16 is, for example, 2 μm.

Light is incident on entry port 1. The incident light propagates through waveguide 20. In coupler 30, the light is split into waveguide 24 and waveguide 26. The ratio of the intensities of the split lights is, for example, 1:1.

The light propagates through waveguide 24 and waveguide 26. The number of modes of light is two or more. For example, the mode of light propagating through section 24a of waveguide 24 is a TE0 mode. The mode of the light propagating through section 24b is a TE1 mode. The mode of light propagating through section 26a of waveguide 26 is, for example, the TE0 mode. The mode of the light propagating through section 26b is, for example, the TE1 mode. Mode conversion of light is performed between section 24a and section 24b of waveguide 24. Mode conversion of light is performed between section 26a and section 26b of waveguide 26.

The light propagating through waveguide 24 and the light propagating through waveguide 26 enter coupler 32 and are combined in coupler 32. The combined light propagates through waveguide 28 and is emitted from exit port 2.

As described above, optical filter 100 splits incident light into a plurality of waveguides, causes the split lights to propagate through the waveguides in two different modes (for example, TE0 mode and TE1 mode), and combines and output the split lights.

### (Design Apparatus)

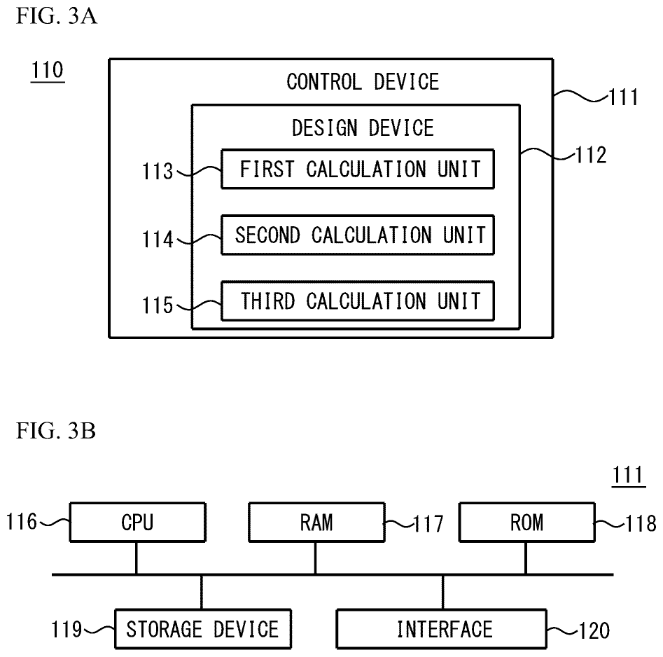

FIG. 3A is a block diagram illustrating a design apparatus 110 for optical filter 100. Design apparatus 110 designs the length of each of the sections of optical filter 100.

Design apparatus 110 includes a control device 111. Control device 111 is a computer or the like, and functions as a design device 112. Design device 112 includes a first calculation unit 113, a second calculation unit 114, and a third calculation unit 115. The functions of the respective units in control device 111 will be described later.

FIG. 3B is a block diagram illustrating a hardware configuration of control device 111. As illustrated in FIG. 3B, control device 111 includes a central processing unit (CPU) 116, a random access memory (RAM) 117, a read only memory (ROM) 118, a storage device 119, and an interface 120. CPU 116, RAM 117, ROM 118, storage device 119, and interface 120 are connected to each other with a bus or the like. RAM 117 is a volatile memory for temporarily storing a program, data, and the like. Storage device 119 is, for example, a solid state drive (SSD) such as a flash memory, or a hard disk drive (HDD). Storage device 119 stores a program and the like.

CPU 116 executes the program stored in RAM 117, so that design device 112 is implemented in control device 111. Each unit of control device 111 may be hardware such as a circuit.

### (Calculation of Section Length)

Design apparatus 110 designs the length of each of the sections of optical filter 100 based on the following Equation 2. The matrix on the left side of Equation 2 may be denoted as a matrix A. The column vector on the left side of Equation 2 may be denoted by column vector L. A first term on the right side of Equation 2 may be denoted as column vector B, and a second term thereof may be denoted as column vector C.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) + ( \begin{matrix}\frac{\partial ϕ}{\partial T} \\ \frac{{\partial }^{2} ϕ}{\partial T \partial λ} \\ \frac{\partial ϕ}{\partial k} \\ \frac{{\partial }^{2} ϕ}{\partial T \partial w}\end{matrix} ) \qquad [ Equation 2 ]$$

In Equation 2, β1 to βn each denote a propagation constant of section. L1 to Ln each denote a length of section. The indices 1 to n in βn and Ln each denote a number corresponding to section. For example, β1 is a propagation constant of section 24a of waveguide 24. L1 is a length of section 24a. T denotes a temperature of optical filter 100. λ denotes a wavelength of light propagating through optical filter 100. Symbol k denotes a wave number. Symbol w denotes a width of section. FSR denotes an interval between adjacent peaks in a transmission spectrum of optical filter 100. ϕ denotes the sum of a phase change amount of light that occurs when different sections are connected to each other.

Matrix A on the left side of Equation 2 will be described below. Matrix A is a four-by-n matrix (i.e., four rows by n columns matrix). Each component in the first row of matrix A is a partial differentiation of the propagation constant with respect to temperature T. Each component in the second row is a partial differentiation of the propagation constant with respect to temperature T and wavelength 2. Each component in the third row is a partial differentiation of the propagation constant with respect to wave number k. Each component in the fourth row is a partial differentiation of the propagation constant with respect to temperature T and width w of section. The components of column vector L on the left side of Equation 2 are the lengths of the sections.

The first term on the right side of Equation 2 is column vector B. The numerator of the third row of column vector B is the square of wavelength λ. The denominator is FSR. The first, second and fourth rows are zero.

The second term on the right side of Equation 2 is column vector C, and may be referred to as a correction term. The first row of column vector C is a partial differentiation of the phase change amount ϕ with respect to temperature T. The second row is a partial differentiation of the phase change amount ϕ with respect to temperature T and wavelength λ. The third row is a partial differentiation of the phase change amount ϕ with respect to wave number k. The fourth row is a partial differentiation of the phase change amount ϕ with respect to temperature T and width w of section.

The propagation constant is proportional to the refractive index of the section and depends on the width of the section. By determining the width of the section, the propagation constant is determined, and matrix elements of matrix A are determined. The elements of column vector B are determined by wavelength λ of the light propagating through optical filter 100 and the magnitude of FSR. Phase change amount ϕ depends on a shape of the waveguide. By determining the shape of the waveguide, phase change amount ϕ is determined, and the components of column vector C are determined as well.

The temperature of optical filter 100 may change, so that there may be an error occurred in the width of the waveguide. By designing the section length based on the above equation, it is possible to suppress a change in characteristics when a temperature change and a width change occur.

As illustrated in FIG. 1, optical filter 100 has section 24a, section 24b, section 26a, and section 26b. The lengths of these four sections L1, L2, L3 and L4 are calculated. By setting index n to four in Equation 2, Equation 3 is obtained. In Equation 3, matrix A is four-by-four matrix. Each of column vector L, column vector B, and column vector C is a column vector having 4 rows.

$$( \begin{matrix}\frac{\partial β 1}{\partial T} & \frac{\partial β 2}{\partial T} & \frac{\partial β 3}{\partial T} & \frac{\partial β 4}{\partial T} \\ \frac{{\partial }^{2} β 1}{\partial T \partial λ} & \frac{{\partial }^{2} β 2}{\partial T \partial λ} & \frac{{\partial }^{2} β 3}{\partial T \partial λ} & \frac{{\partial }^{2} β 4}{\partial T \partial λ} \\ \frac{\partial β 1}{\partial k} & \frac{\partial β 2}{\partial k} & \frac{\partial β 3}{\partial k} & \frac{\partial β4}{\partial k} \\ \frac{{\partial }^{2} β 1}{\partial T \partial w} & \frac{{\partial }^{2} β2}{\partial T \partial w} & \frac{{\partial }^{2} β 3}{\partial T \partial w} & \frac{{\partial }^{2} β 4}{\partial T \partial w}\end{matrix} ) ( \begin{matrix}L 1 \\ L 2 \\ L 3 \\ L 4\end{matrix} ) = ( \begin{matrix}0 \\ 0 \\ \frac{{λ}^{2}}{FSR} \\ 0\end{matrix} ) + ( \begin{matrix}\frac{\partial ϕ}{\partial T} \\ \frac{{\partial }^{2} ϕ}{\partial T \partial λ} \\ \frac{\partial ϕ}{\partial k} \\ \frac{{\partial }^{2} ϕ}{\partial T \partial w}\end{matrix} ) \qquad [ Equation 3 ]$$

The second terms (correction terms) on the right sides of Equation 2 and Equation 3 may or may not be considered in the design. When each component of the second term on the right side is set to zero in Equation 2, Equation 4 is obtained.

$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad [ Equation 4 ]$$

When index n is set to four (n=4) in Equation 4, Equation 5 is obtained. In a design example described later, Equation 5 is used.

$$( \begin{matrix}\frac{\partial β 1}{\partial T} & \frac{\partial β 2}{\partial T} & \frac{\partial β 3}{\partial T} & \frac{\partial β 4}{\partial T} \\ \frac{{\partial }^{2} β 1}{\partial T \partial λ} & \frac{{\partial }^{2} β 2}{\partial T \partial λ} & \frac{{\partial }^{2} β 3}{\partial T \partial λ} & \frac{{\partial }^{2} β 4}{\partial T \partial λ} \\ \frac{\partial β 1}{\partial k} & \frac{\partial β 2}{\partial k} & \frac{\partial β 3}{\partial k} & \frac{\partial β4}{\partial k} \\ \frac{{\partial }^{2} β 1}{\partial T \partial w} & \frac{{\partial }^{2} β2}{\partial T \partial w} & \frac{{\partial }^{2} β 3}{\partial T \partial w} & \frac{{\partial }^{2} β 4}{\partial T \partial w}\end{matrix} ) ( \begin{matrix}L 1 \\ L 2 \\ L 3 \\ L 4\end{matrix} ) = ( \begin{matrix}0 \\ 0 \\ \frac{{λ}^{2}}{FSR} \\ 0\end{matrix} ) \qquad [ Equation 5 ]$$

### (Method of Manufacturing)

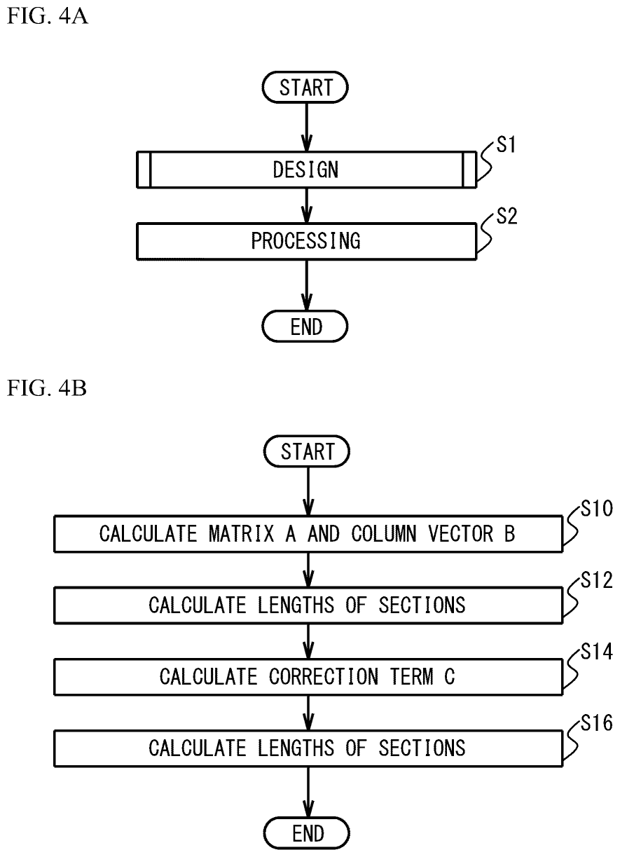

FIG. 4A and FIG. 4B are flowcharts illustrating a method of manufacturing optical filter 100. As illustrated in FIG. 4A, a design process is performed to design a length and a width of a waveguide (step S1). A wafer is processed to form a waveguide based on the design (step S2).

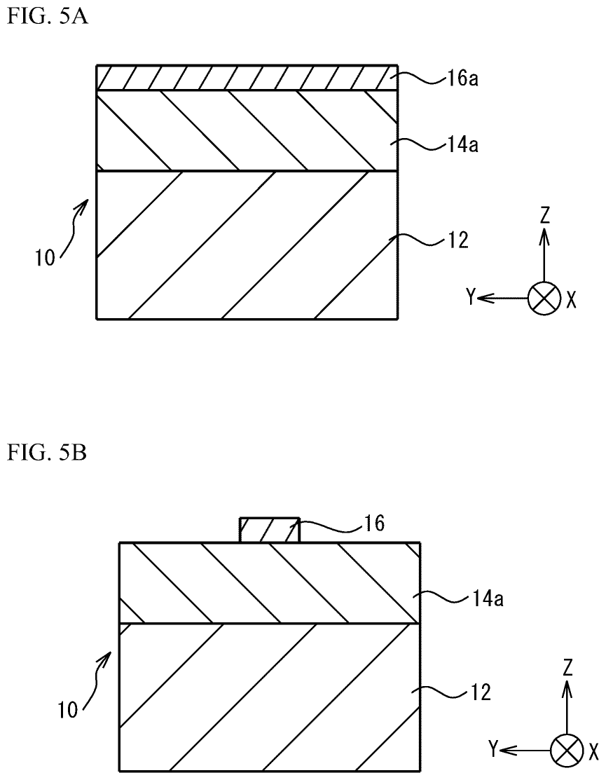

FIG. 5A and FIG. 5B are cross-sectional views illustrating the method of manufacturing optical filter 100. As illustrated in FIG. 5A, a box layer 14a and a silicon layer 16a are stacked in order on one surface of substrate 12. A resist pattern (not illustrated) is provided on silicon layer 16a. As illustrated in FIG. 5B, silicon layer 16a is etched to form waveguide core 16 from silicon layer 16a. A silicon oxide layer is further stacked on box layer 14a to form box layer 14. Optical filter 100 is formed by cutting the wafer.

As described above, waveguide core 16 is manufactured by etching silicon layer 16a. There may be an error occurred in the width of the waveguide. In the first embodiment, the deterioration of the characteristics due to the deviation of the width is suppressed.

FIG. 4B is a flowchart illustrating the design process, which corresponds to step S1 of FIG. 4A. First calculation unit 113 of control device 111 calculates matrix A and column vector B (step S10). First calculation unit 113 sweeps a width of section and calculates the matrix elements of matrix A corresponding to each width. First calculation unit 113 calculates λ²/FSR of column vector B based on a wavelength of light and FSR.

Third calculation unit 115 calculates L1, L2, L3, and L4 in column vector L using matrix A and column vector B obtained in step S10 (step S12). At the time of step S12, calculation is performed without considering the correction term (column vector C), and lengths L1, L2, L3, and L4 of the sections corresponding to the swept widths are calculated.

Second calculation unit 114 calculates the correction term (step S14). Third calculation unit 115 calculates the lengths of each of the sections in consideration of the correction term (step S16). In detail, appropriate values are selected from the widths and the section lengths obtained in step S12. When the width is large, the waveguide is easy to manufacture. The shorter the section of the waveguide is, the more optical filter 100 can be miniaturized. In order to achieve both high productivity and miniaturization, it is effective that the width is large and the section is short. For example, third calculation unit 115 selects a width and a section length suitable for such a request, and adds column vector C to the selected section length. That is, the section length is calculated using Equation 2 (step S16). The process of FIG. 4B is then complete.

### Comparative Example

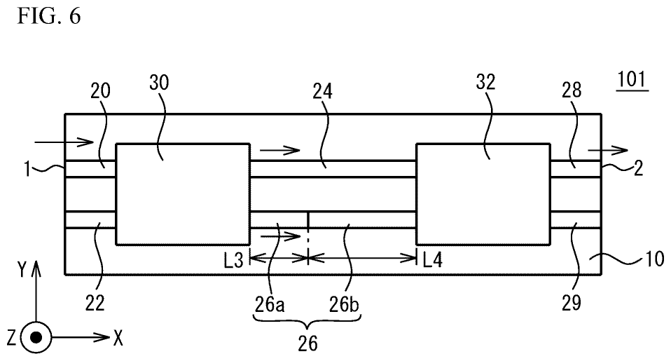

FIG. 6 is a schematic diagram illustrating an optical filter 101 according to a comparative example. Optical filter 101 has three sections. Waveguide 26 has section 26a and section 26b. Waveguide 24 functions as one section. The mode of light propagating through waveguide 24 is the TE1 mode. The mode of the light propagating through section 26a of waveguide 26 is the TE0 mode. The mode of the light propagating through section 26b is the TE0 mode. The width of waveguide 24 is 600 nm. The width of section 26a is 400 nm. The width of section 26b is 270 nm.

In the calculation of the section length in the comparative example, Equation 6 is used.

$$( \begin{matrix}\frac{\partial β 1}{\partial T} & \frac{\partial β 3}{\partial T} & \frac{\partial β 4}{\partial T} \\ \frac{{\partial }^{2} β 1}{\partial T \partial λ} & \frac{{\partial }^{2} β 3}{\partial T \partial λ} & \frac{{\partial }^{2} β 4}{\partial T \partial λ} \\ \frac{\partial β 1}{\partial k} & \frac{\partial β 3}{\partial k} & \frac{\partial β4}{\partial k}\end{matrix} ) ( \begin{matrix}L 1 \\ L 3 \\ L 4\end{matrix} ) = ( \begin{matrix}0 \\ 0 \\ \frac{{λ}^{2}}{FSR}\end{matrix} ) \qquad [ Equation 6 ]$$

Equation 6 includes three section lengths L1, L3 and L4, but does not include section length L2, and does not include the differentiations of the propagation constants with respect to a temperature and a width. Section lengths L1, L3, and L4 are calculated by Equation 6. As a result of calculation, section length L1 of waveguide 24 is 253.6 μm. Section length L3 of section 26a is 31.7 μm. Section length L4 of section 26b is 326.7 μm.

### (Spectrum)

The optical filter is applied to wavelength division multiplexing (WDM), and a spectrum in a wavelength band of the C band is calculated.

### (CWDM)

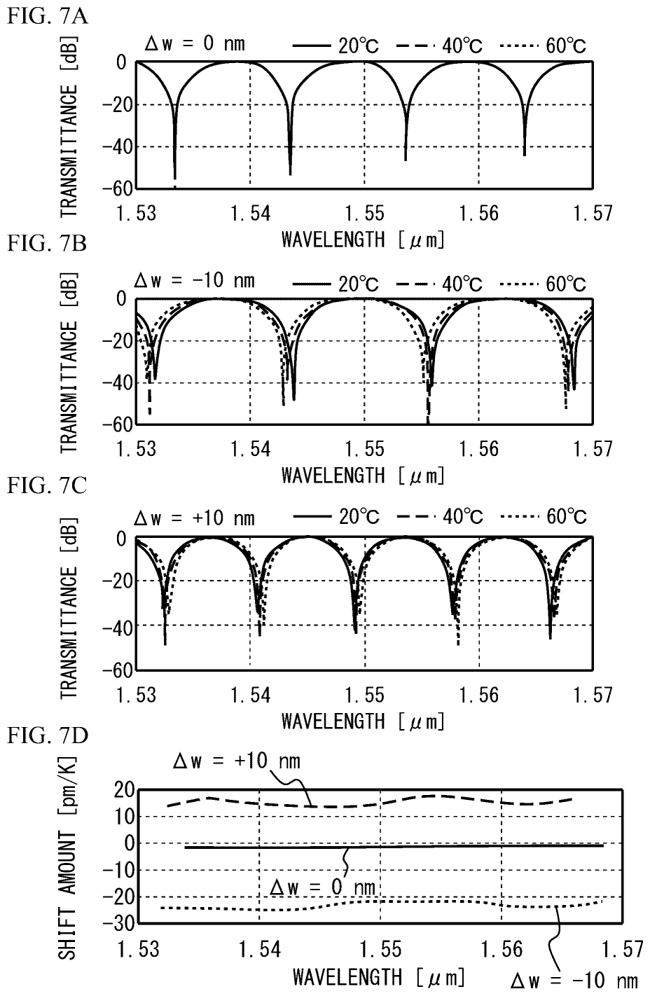

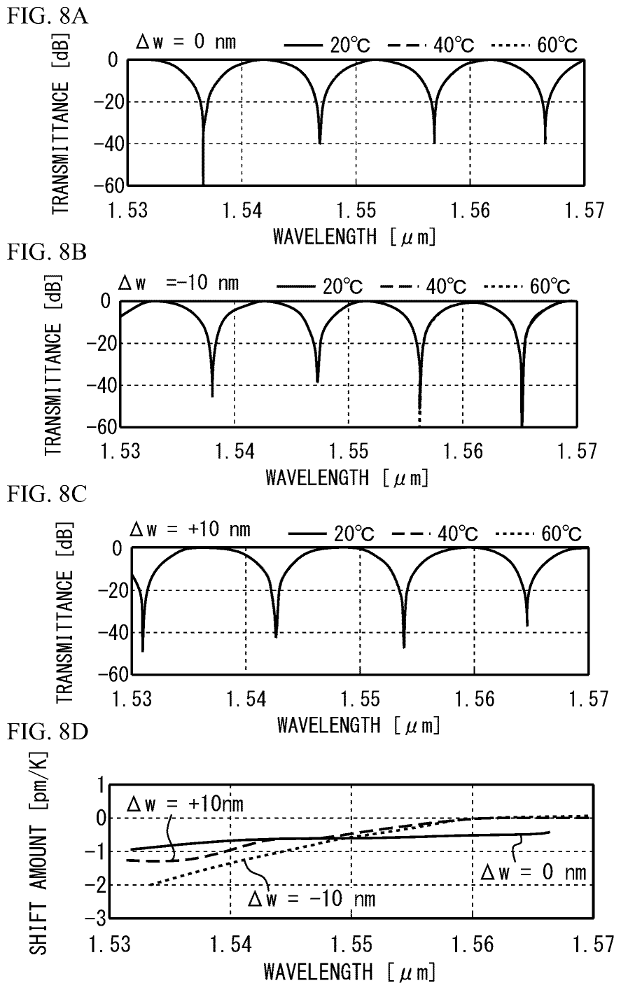

FIG. 7A to FIG. 8D illustrate examples of coarse wavelength division multiplexing (CWDM).

FIG. 7A to FIG. 7D illustrate comparative examples. The horizontal axes in FIG. 7A to FIG. 7D each represent a wavelength of light. FIG. 7A to FIG. 7C are diagrams illustrating calculated spectra for optical filter 101 in the comparative example. Vertical axes in FIG. 7A to FIG. 7C each represent a light transmittance. A solid line is an example for a temperature of 20° C. A dashed line is an example for a temperature of 40° C. A dotted line is an example for a temperature of 60° C. FSR is 10 nm.

FIG. 7A illustrates spectra when an error in a width of section is 0 nm (Δw=0 nm). That is, the widths of all the sections are equal to the design value. FIG. 7B illustrates spectra when an error in a width of section is −10 nm (Δw=−10 nm). The width of each of the three sections is narrower than a design value by 10 nm. FIG. 7C illustrates spectra when an error in a width of section is +10 nm (Δw=+10 nm). The width of each of the three sections is wider than the design value by 10 nm.

FIG. 7D is a diagram illustrating a shift amount in the comparative example, and illustrates the shift amount of the wavelength calculated from the spectra in FIG. 7A to FIG. 7C. A vertical axis in FIG. 7D represents the shift amount of the spectra, and represents the amounts of shift of the wavelength of the spectra with respect to a temperature change of 1K. A solid line represents an example for Δw=0 nm, and represents the shift amount in the spectra of FIG. 7A. A dotted line represents an example for Δw=−10 nm, and represents the shift amount in the spectra of FIG. 7B. A dashed line represents an example for Δw=+10 nm, and represents the shift amount in the spectra of FIG. 7C.

As illustrated in FIG. 7A and FIG. 7D, in the case of Δw=0 nm, the shift amount of the spectra is close to zero at any wavelength in the wavelength range illustrated in the graphs. As illustrated in FIG. 7B, in the case of Δw=−10 nm, the spectra shift in the negative direction at any wavelength in the wavelength range in the graph as the temperature increases. As illustrated in FIG. 7D, the shift amount is −20 pm or less per 1K of temperature. As illustrated in FIG. 7C, in the case of Δw=+10 nm, the spectra shift in the positive direction at any wavelength in the wavelength range in the graph as the temperature increases. As illustrated in FIG. 7D, the shift amount is +10 μm or more per 1K of temperature.

FIG. 8A to FIG. 8D illustrate calculation results for optical filter 100 of the first embodiment. The parameters used for the calculation are as follows. In optical filter 100 in FIG. 1, the mode of light propagating through section 24a of waveguide 24 is the TE0 mode, and the mode of light propagating through section 24b is the TE1 mode. The mode of the light propagating through section 26a of waveguide 26 is the TE0 mode, and the mode of the light propagating through section 26b is the TE1 mode. The width of section 24a is 390 nm. The width of section 24b is 720 nm. The width of section 26a is 1200 nm. The width of section 26b is 600 nm.

In the calculation of section lengths L1 to L4 in the first embodiment, Equation 5 is used with each component of column vector C (second term on the right side) in Equation 3 being set to zero. That is, the section length is calculated by performing steps S10 and S12 in FIG. 4B without performing steps S14 and S16. As a result of calculation, section length L1 of section 24a is 723.7 μm. Section length L2 of section 24b is 237.5 μm. Section length L3 of section 26a is 525.9 μm. Section length L4 of section 26b is 109.4 μm.

FIG. 8A to FIG. 8C are diagrams illustrating spectra in the first embodiment. The spectra for optical filter 100 when the parameters are set to the above-described values are illustrated in the figures. Horizontal axes in FIG. 8A to FIG. 8D each represent a wavelength of light. Vertical axes of FIG. 8A to FIG. 8C each represent a light transmittance. FIG. 8A illustrates spectra when an error in a width of section is 0 nm (Δw=0 nm). The width of each of the four sections is equal to a design value. FIG. 8B illustrates spectra when an error in a width of section is −10 nm (Δw=−10 nm). The width of each of the four sections is narrower than the design value by 10 nm. FIG. 8C illustrates spectra when an error in a width of section is +10 nm (Δw=+10 nm). The width of each of the four sections is wider than the design value by 10 nm. FIG. 8D is a diagram illustrating a shift amount in the first embodiment, and illustrates the shift amounts of the wavelength of the spectra in FIG. 8A to FIG. 8C. A vertical axis in FIG. 8D represents shift amounts of the spectra, and represents the amounts of shift of the wavelength of the spectra with respect to a temperature change of 1K.

In each of the examples in FIG. 8A to FIG. 8C, the three spectra substantially overlap with each other. As illustrated in FIG. 8D, in the case of Δw=0 nm, the shift amounts of the spectra are within about −1 pm per 1K of temperature. In the case of Δw=−10 nm, the shift amounts are within about −2 pm per 1K of temperature. In the case of Δw=+10 nm, the shift amounts are within −2 pm per 1K of temperature. Each of the shift amounts in the first embodiment is about 1/10 of each of the shift amounts in the comparative example.

### (DWDM)

Next, an example in which optical filter 100 is used for dense wavelength division multiplexing (DWDM) will be described.

The optical filter is designed based on Equation 5. The parameters used for the calculation of the spectrum are illustrated below. The mode of the light propagating through section 24a of waveguide 24 is the TE0 mode, and the mode of the light propagating through section 24b is the TE1 mode. The mode of the light propagating through section 26a of waveguide 26 is the TE0 mode, and the mode of the light propagating through section 26b is the TE1 mode. Section 24a of waveguide 24 has a width w1 of 390 nm and a section length L1 of 9.0 mm. Section 24b of waveguide 24 has a width w2 of 720 nm and a section length L2 of 3.0 mm. Section 26a of waveguide 26 has a width w3 of 1200 nm and a section length L3 of 6.6 mm. Section 26b of waveguide 26 has a width w4 of 600 nm and a section length L4 of 1.4 mm.

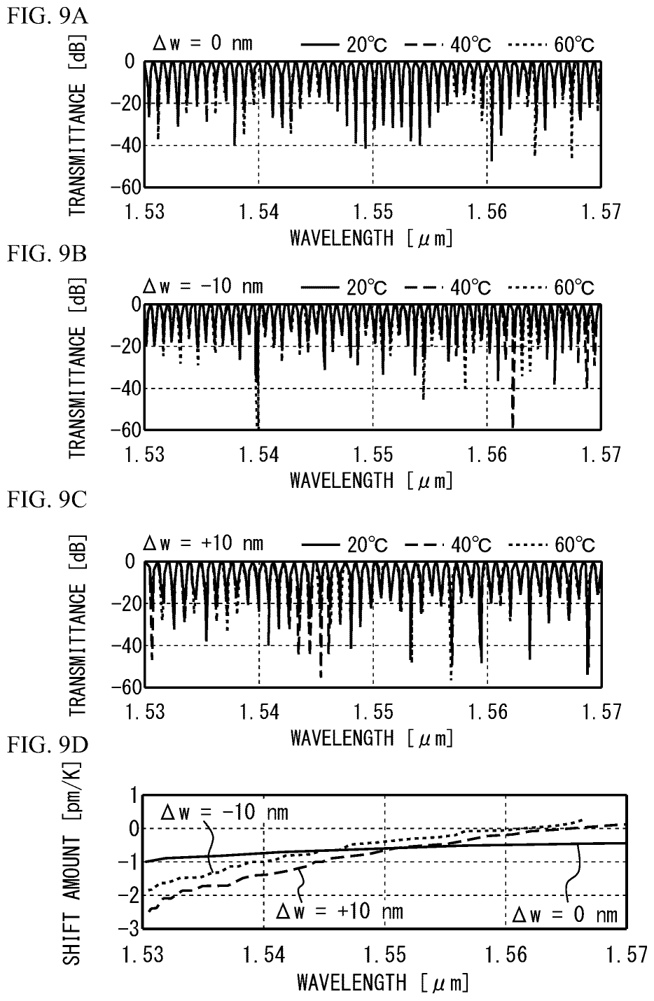

FIG. 9A to FIG. 9C are diagrams illustrating the spectra in the first embodiment, and illustrate the spectra for optical filter 100 when the parameters are set to the above-described values. FSR is 0.8 nm. FIG. 9A illustrates spectra when an error in a width of section is 0 nm (Δw=0 nm). FIG. 9B illustrates spectra when an error in a width of section is −10 nm (Δw=−10 nm). FIG. 9C illustrates spectra when an error in a width of section is +10 nm (Δw=+10 nm). FIG. 9D is a diagram illustrating the shift amounts of the spectra.

In each of the examples of FIG. 9A to FIG. 9C, the three spectra substantially overlap with each other. As illustrated in FIG. 9D, in the case of Δw=0 nm, the shift amounts of the spectra are within about −1 pm per 1K of temperature. In the case of Δw=−10 nm, the shift amounts are in a range from −2 μm to 0.5 pm per 1K of temperature. In the case of Δw=+10 nm, the shift amounts are within a range from −3 μm to 0.5 pm per 1K of temperature. According to the first embodiment, in both DWDM and CWDM, even when the width of waveguide change by ±10 nm from the design value, an absolute value of a wavelength shift amount of each spectrum with respect to a temperature change can be suppressed to several pm/K.

According to the first embodiment, optical filter 100 includes waveguide 24 and waveguide 26. Waveguide 24 has section 24a and section 24b. Waveguide 26 has section 26a and section 26b. There are two modes (TE0 mode and TE1 mode) of light propagating through the four sections. The lengths of the sections are designed based on the differentiations of the propagation constants βn with respect to temperature T and width w of section. The tolerance to a manufacturing error can be improved by setting the section lengths to appropriate sizes. Even when the widths of the waveguides deviate from the design values, the temperature dependency is suppressed, and the change in the characteristics can be suppressed.

For example, as illustrated in FIG. 8D and FIG. 9D, when the widths of the waveguides are changed by ±10 nm from the design values, the shift amount is about several pm per 1K of temperature. That is, even when an error occurs in width, the shift of the spectrum due to a temperature change can be suppressed.

The lengths of the sections are designed based on Equation 2 to Equation 5. Matrix A on the left side of Equations includes differentiations of the propagation constants with respect to temperature T, differentiations of the propagation constants with respect to temperature T and wavelength λ, differentiations of the propagation constants with respect to wave number k, and differentiations of the propagation constants with respect to temperature T and width w. The column vector on the left side includes section lengths L1 to Ln. The first term on the right side includes wavelength λ and FSR. The second terms on the right sides of Equation 2 and Equation 4 include phase change amount ϕ. Section lengths L1 to Ln can be calculated. The temperature dependency of characteristics can be suppressed and the tolerance can be improved.

Optical filter 100 in FIG. 1 has four sections. When the number of sections is four (n=4), section lengths L1 to L4 are designed by using Equation 3. In optical filter 100, even when the widths of the waveguides change, the temperature dependency can be suppressed.

In the design process, Equation 2 or Equation 3 may be used, or Equation 4 or Equation 5 may be used. As illustrated in FIG. 8D and FIG. 9D, even if the correction term (the second terms on the right sides of Equation 2 and Equation 3) is not included, the shift amount of the spectrum with respect to the change in width can be suppressed. An amount of calculation for designing the section lengths can be reduced. By designing the section lengths in consideration of the correction term, the change in the characteristics can be further suppressed.

As illustrated in FIG. 1, optical filter 100 includes two waveguides 24 and 26, and has four sections 24a, 24b, 26a, and 26b. The number of sections may be four or more, or may be five or more. With index n in Equation 2 and Equation 4 set to the number of sections, the length of each of the sections is designed. In Equation 3 and Equation 5, index n is four (n=4), and the matrix on the left side is a four-by-four square matrix. When the number of sections n is five or more, the matrix is not a square matrix. The section lengths can be obtained by multiplying the matrix by a generalized inverse matrix of the matrix from the left of the matrix.

The number of modes of light propagating through the four or more sections is two or more. In the example of FIG. 1, the TE0 mode light and the TE1 mode light propagate. The number of modes may be three or more, and for example, a TM0 mode light may be propagated in addition to the TE0 mode and the TE1 mode.

In the design process, the propagation constants βn are determined by determining the widths of the sections, and each term in matrix A is calculated. Section lengths L1 to Ln are calculated corresponding to widths using Equation 2. As illustrated in FIG. 5A and FIG. 5B, the waveguide is manufactured by etching silicon layer 16a. When the width is small, it is difficult to manufacture the waveguide. The larger the width, the easier the manufacturing. For example, the width is swept, and the section length for each width is calculated. A value of the width that is easy to manufacture is selected, and a section length corresponding to the width is adopted. Silicon layer 16a is etched to manufacture a waveguide having the width and the section length. The temperature dependency can be suppressed and the tolerance can be improved.

When sweeping the width and searching for the appropriate section length, the correction term (the second term on the right side of Equation 2) may be calculated for all of the swept widths. In order to reduce the amount of calculation, the correction term may not be calculated for all of the swept widths, but only a part of the correction terms may be calculated. For the widths to be swept, the section lengths without considering the correction term are calculated. For example, a set of small values among the calculated section lengths is set as a candidate of the section length. A correction term corresponding to the candidate of the section lengths is calculated, and the section lengths are calculated by the correction term and the candidate (FIG. 4B). As described above, the section lengths may be calculated without considering the correction term.

Matrix A corresponding to an estimated width candidate may be calculated in advance and stored in control device 111. The wavelength of light propagating through optical filter 100 and FSR of the spectrum may be determined, and column vector B may be calculated in advance and stored in control device 111. The section length is proportional to the square of the wavelength λ and inversely proportional to FSR. FSR may be 10 nm or more, 10 nm or less, or 1 nm or less. The spectrum has periodic peaks. By appropriately designing the section lengths, the temperature dependency of characteristics can be suppressed even when a width changes.

The optical filter may be formed in an SOI substrate or may be formed in a component other than an SOI substrate. The waveguide may include waveguide core 16 formed of Si or may be formed of other materials.

### Second Embodiment

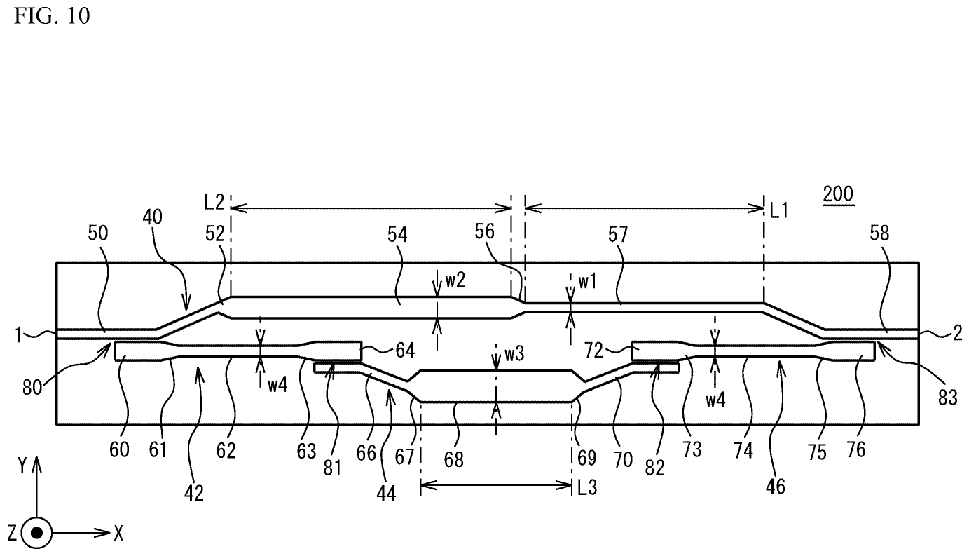

FIG. 10 is a plan view illustrating an optical filter 200 according to a second embodiment. The description of the same configuration as that of the first embodiment will be omitted. As illustrated in FIG. 10, optical filter 200 includes a waveguide 40, a waveguide 42, a waveguide 44, and a waveguide 46. These four waveguides are provided in substrate 10. Waveguide 40 extends from one end to the other end of substrate 10 in the X-axis direction, and has entry port 1 and exit port 2.

Waveguide 42, waveguide 44, and waveguide 46 are disposed side by side with waveguide 40 in the Y-axis direction. Waveguide 42, waveguide 44, and waveguide 46 are disposed in order of proximity to entry port 1.

Waveguide 40 has a portion 50, a portion 52, a section 54, a portion 56, a section 57, and a portion 58. Portion 50, portion 52, section 54, portion 56, section 57, and portion 58 are disposed in this order in the X-axis direction. Portion 50 has entry port 1. Portion 58 has exit port 2.

Width w2 of section 54 is greater than the widths of portion 50 and section 57, and is, for example, 800 nm. Width w1 of section 57 is smaller than width w2, and is, for example, 400 nm. Portion 52 and portion 56 each have a tapered shape. Portion 52 is connected to portion 50 and section 54. The width of portion 52 increases from portion 50 toward section 54. Portion 56 is connected to section 54 and section 57. The width of portion 56 decreases from section 54 toward section 57.

Waveguide 42 has a portion 60, a portion 61, a section 62, a portion 63, and a portion 64. Portion 60, portion 61, section 62, portion 63, and portion 64 are disposed in this order in the X-axis direction. The widths of portion 60 and portion 64 of waveguide 42 are greater than the widths of portion 50 and portion 58 of waveguide 40. Width w4 of section 62 is smaller than the widths of portion 60 and portion 64 and width w2 of section 54 of waveguide 40, and is greater than width w1 of section 57 of waveguide 40, for example, 600 nm.

Portion 61 and portion 63 each have a tapered shape. Portion 61 is connected to portion 60 and section 62. The width of portion 61 decreases from portion 60 toward section 62. Portion 63 is connected to section 62 and portion 64. The width of portion 63 increases from section 62 toward portion 64.

Waveguide 44 has a portion 66, a portion 67, a section 68, a portion 69, and a portion 70. Portion 66, portion 67, section 68, portion 69, and portion 70 are disposed in this order in the X-axis direction. The widths of portion 66 and portion 70 are smaller than the widths of portion 60 and portion 64 of waveguide 42. Width w3 of section 68 is greater than the widths of portion 66 and portion 70, and is greater than width w2 of section 54 of waveguide 40, for example, 1200 nm.

Portion 67 and portion 69 each have a tapered shape. Portion 67 is connected to portion 66 and section 68. The width of portion 67 increases from portion 66 toward section 68. Portion 69 is connected to section 68 and portion 70. The width of portion 69 decreases from section 68 to portion 70.

The shape of waveguide 46 is the same as the shape of waveguide 42. Waveguide 46 has a portion 72, a portion 73, a section 74, a portion 75, and a portion 76. Portion 72, portion 73, section 74, portion 75, and portion 76 are disposed in this order in the X-axis direction. Portion 73 and portion 75 each have a tapered shape. Width w4 of section 74 is, for example, 600 nm.

Section 57 of waveguide 40 corresponds to section 24a in FIG. 1. Section 54 corresponds to section 24b. Section 68 of waveguide 44 corresponds to section 26a. Section 62 of waveguide 42 and section 74 of waveguide 46 each correspond to section 26b.

Portion 50 of waveguide 40 and portion 60 of waveguide 42 form a directional coupler 80. Directional coupler 80 corresponds to coupler 30 in FIG. 1. Portion 64 of waveguide 42 and portion 66 of waveguide 44 form a directional coupler 81. Portion 70 of waveguide 44 and portion 72 of waveguide 46 form a directional coupler 82. Portion 76 of waveguide 46 and portion 58 of waveguide 40 form a directional coupler 83. Directional coupler 83 corresponds to coupler 32 in FIG. 1.

Light enters into waveguide 40 from entry port 1. Part of the light propagates through waveguide 40, and the other part of the light is transferred to waveguide 42 by directional coupler 80. The mode of light propagating through waveguide 40 is the TE0 mode. The TE0 mode light propagates through section 54 and section 57.

The mode of the light is converted in directional coupler 80. The mode of the light propagating through waveguide 42 is the TE1 mode. In directional coupler 81, the light is transferred from waveguide 42 to waveguide 44, and the mode is converted from the TE1 mode to the TE0 mode. The TE0 mode light propagates through waveguide 44. In directional coupler 82, the light is transferred from waveguide 44 to waveguide 46, and the mode is converted from the TE0 mode to the TE1 mode. The TE1 mode light propagates through waveguide 46. In directional coupler 83, the light is transferred from waveguide 46 to waveguide 40, and the mode is converted from the TE1 mode to the TE0 mode. The TE0 mode light propagates through waveguide 40 and is emitted from exit port 2 to the outside of optical filter 200.

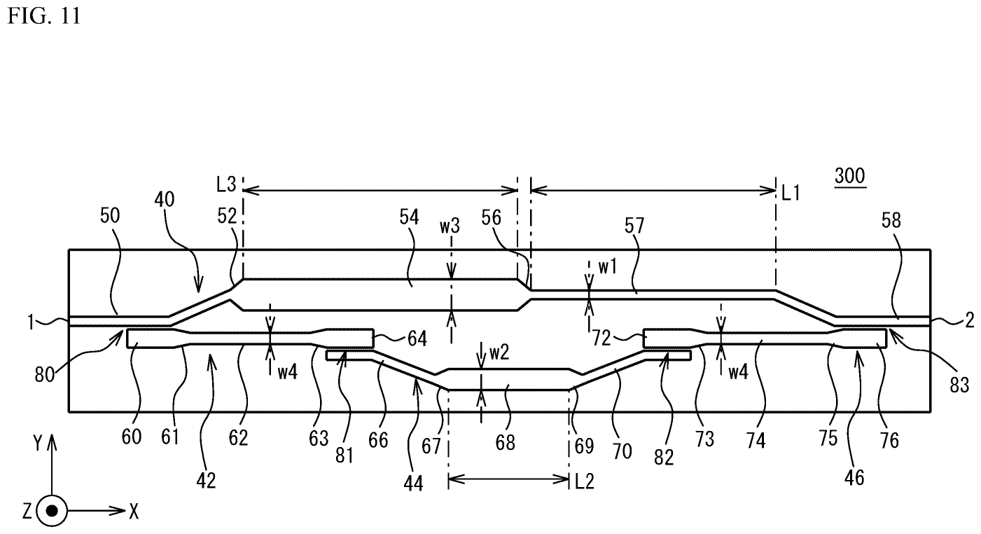

Length L1 of section 57, length L2 of section 54, length L3 of section 68, and length L4 of the sum of section 62 and section 74 are designed by design apparatus 110. The width of each of the sections is set to the above values, and Equation 5 is used. As a result of calculation, length L1 of section 57 is 8587 μm. Length L2 of section 54 is 7358 μm. Length L3 of section 68 is −15762 μm. Length L4, which is the sum of section 62 and section 74, is −865 μm. Waveguide 40 having a positive value of section length corresponds to waveguide 24 in FIG. 1. Waveguide 42, waveguide 44 and waveguide 46 each having a negative section length correspond to waveguide 26 in FIG. 1. In FIG. 10, in the Y-axis direction, waveguide 40 is disposed at an upper portion of optical filter 200, and waveguide 42, waveguide 44, and waveguide 46 are disposed at a lower portion thereof. That is, the positive value of section length indicates the section length of the waveguide disposed at the upper portion of the optical filter, and the negative value of section length indicates the section length of the waveguide disposed at the lower portion of the optical filter (the same applies to FIG. 11).

According to the second embodiment, optical filter 200 has section 54, section 57, section 62, section 68, and section 74. The TE0 mode light propagates through section 54, section 57, and section 68. The TE1 mode light propagates through section 62 and section 74. The lengths of the sections are designed based on the differentiations of the propagation constants βn with respect to temperature T and width w of section. The tolerance can be improved by setting the section lengths to appropriate sizes. Even when the widths of the waveguides change, the temperature dependency is suppressed, and the change in the characteristics can be suppressed.

### Third Embodiment

FIG. 11 is a plan view illustrating an optical filter 300 according to a third embodiment. The description of the same configuration as that of the first embodiment or the second embodiment will be omitted.

In the example of FIG. 11, the length of section 54 of waveguide 40 is denoted as length L3, and the width of section 54 is denoted as width w3. The length of section 68 of waveguide 44 is denoted as length L2, and the width of section 68 is denoted as width w2.

Width w1 of section 57 of waveguide 40 is, for example, 410 nm. Width w2 of section 68 of waveguide 44 is, for example, 800 nm. Width w3 of section 54 of waveguide 40 is, for example, 1200 nm. Width w4 of each of section 62 of waveguide 42 and section 74 of waveguide 46 is, for example, 600 nm.

The mode of light propagating through section 54 and section 57 of waveguide 40 is the TE0 mode. The mode of the light propagating through section 62 of waveguide 42 and section 74 of waveguide 46 is the TE1 mode. The mode of the light propagating through section 68 of waveguide 44 is the TE0 mode.

Length L1 of section 57, length L2 of section 68, length L3 of section 54, and length L4 of the sum of section 62 and section 74 are designed by design apparatus 110. As a result of calculation, length L1 of section 57 is 13016 μm. Length L2 of section 68 is −24829 μm. Length L3 of section 54 is 12760 μm. Length L4, which is the combined length of section 62 and section 74 is −1312 μm. Waveguide 40 having a positive value of section length corresponds to waveguide 24 in FIG. 1. Waveguide 42, waveguide 44 and waveguide 46 each having a negative section length correspond to waveguide 26 in FIG. 1. In FIG. 11, in the Y-axis direction, waveguide 40 is disposed at an upper portion of optical filter 300, and waveguide 42, waveguide 44, and waveguide 46 are disposed at a lower portion thereof.

According to the third embodiment, the lengths of the sections of optical filter 300 are designed based on the differentiations of the propagation constants βn with respect to temperature T and width w of section. The tolerance can be improved by setting the section lengths to appropriate sizes. Even when the widths of the waveguides changes, the temperature dependency is suppressed, and the change in the characteristics can be suppressed.

In FIG. 10 and FIG. 11, each of portions of the waveguides has a tapered shape. In each of the portions having the tapered shape, the phase of the light changes. By performing design including the second term (correction term) on the right side as in Equation 2 and Equation 3, the section lengths can be calculated in consideration of the phase change.

The functions described above with respect to the design can be enabled by a computer. In this case, a program describing the process contents of the functions to be possessed by a process apparatus is provided. The program is executed by the computer, and thus the process functions are enabled on the computer. The program describing the process contents can be recorded in a non-transitory computer-readable storage media (excluding a carrier wave).

When the program is distributed, for example, the program is sold in a form of a portable storage medium such as a digital versatile disk (DVD) or a compact disc read only memory (CD-ROM) on which the program is recorded. Alternatively, the program may be stored in a storage device of a server computer, and the program may be transferred from the server computer to another computer via a network.

A computer that executes a program stores, for example, the program recorded in a portable storage medium or the program transferred from a server computer in its own storage device. Then, the computer reads the program from the storage device of the computer and executes process in accordance with the program. The computer may read the program directly from the portable storage medium and execute the process in accordance with the program. Further, the computer can also execute process in accordance with the received program each time the program is transferred from the server computer.

Although the embodiments of the present disclosure have been described in detail, the present disclosure is not limited to the specific embodiments, and various modifications and changes can be made within the scope of the gist of the present disclosure described in the claims.

1. A method of manufacturing an optical filter, the optical filter including two or more waveguides, the two or more waveguides having four or more sections, a number of modes of light propagating through the four or more sections being two or more, the method comprising:
designing lengths of the four or more sections; and
forming the two or more waveguides based on the lengths of the four or more sections;
wherein the designing includes designing the lengths of the four or more sections based on differentiations of propagation constants of the sections with respect to a temperature and widths of the sections.

2. The method of manufacturing the optical filter according to claim 1, wherein
the designing the lengths of the four or more sections includes designing the lengths of the four or more sections based on Equation 1:
$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad ( 1 )$$
where
L1 to Ln each denote length of section,
β1 to βn each denote propagation constant of section,
T denotes temperature,
λ denotes wavelength,
k denotes wave number,
FSR denotes interval between peaks of spectrum, and
w denotes width of section.

3. The method of manufacturing the optical filter according to claim 1, wherein
the four or more sections include a first section, a second section, a third section, and a fourth section, and
the designing the lengths of the four or more sections is designing a length of the first section, a length of the second section, a length of the third section, and a length of the fourth section.

4. A method of designing an optical filter, the optical filter including two or more waveguides, the two or more waveguides having four or more sections, a number of modes of light propagating through the four or more sections being two or more, the method comprising:
designing lengths of the four or more sections based on differentiations of propagation constants of the sections with respect to a temperature and widths of the sections.

5. The method of designing the optical filter according to claim 4, wherein
the designing the lengths of the four or more sections includes designing the lengths of the four or more sections based on Equation 1:
$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad ( 1 )$$
where
L1 to Ln each denote length of section,
β1 to βn each denote propagation constant of section,
T denotes temperature,
λ denotes wavelength,
k denotes wave number,
FSR denotes interval between peaks of spectrum, and
w denotes width of section.

6. The method of designing the optical filter according to claim 4, wherein
the four or more sections include a first section, a second section, a third section, and a fourth section, and
the designing the lengths of the four or more sections is designing a length of the first section, a length of the second section, a length of the third section, and a length of the fourth section.

7. A design apparatus for designing an optical filter, the optical filter including two or more waveguides, the two or more waveguides having four or more sections, a number of modes of light propagating through the four or more sections being two or more, the design apparatus comprising:
a designer that designs lengths of the four or more sections based on differentiations of propagation constants of the sections with respect to a temperature and widths of the sections.

8. The design apparatus for designing an optical filter according to claim 7, wherein
the designing the lengths of the four or more sections includes designing the lengths of the four or more sections based on Equation 1:
$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad ( 1 )$$
where
L1 to Ln each denote length of section,
β1 to βn each denote propagation constant of section,
T denotes temperature,
λ denotes wavelength,
k denotes wave number,
FSR denotes interval between peaks of spectrum, and
w denotes width of section.

9. The design apparatus for designing an optical filter according to claim 7, wherein
the four or more sections include a first section, a second section, a third section, and a fourth section, and
the designing the lengths of the four or more sections is designing a length of the first section, a length of the second section, a length of the third section, and a length of the fourth section.

10. A non-transitory computer-readable recording medium having stored therein a program for causing a computer for designing an optical filter to execute a process,
the optical filter including two or more waveguides, the two or more waveguides having four or more sections, a number of modes of light propagating through the four or more sections being two or more, and the process comprising:
designing lengths of the four or more sections based on differentiations of propagation constants of the sections with respect to a temperature and widths of the sections.

11. The non-transitory computer-readable recording medium according to claim 10, wherein
the designing the lengths of the four or more sections includes designing the lengths of the four or more sections based on Equation 1:
$$( \begin{matrix}\frac{\partial β 1}{\partial T} & … & \frac{\partial β n}{\partial T} \\ \frac{{\partial }^{2} β 1}{\partial T \partial λ} & … & \frac{{\partial }^{2} β n}{\partial T \partial λ} \\ \frac{\partial β 1}{\partial k} & … & \frac{\partial β n}{\partial k} \\ \frac{{\partial }^{2} β 1}{\partial T \partial w} & … & \frac{{\partial }^{2} β n}{\partial T \partial w}\end{matrix} ) ( \begin{matrix}L 1 \\ ⋮ \\ L n\end{matrix} ) = ( \begin{matrix}0 \\ 0 \\ \frac{{λ}^{2}}{FSR} \\ 0\end{matrix} ) \qquad ( 1 )$$
where
L1 to Ln each denote length of section,
β1 to βn each denote propagation constant of section,
T denotes temperature,
λ denotes wavelength,
k denotes wave number,
FSR denotes interval between peaks of spectrum, and
w denotes width of section.

12. The non-transitory computer-readable recording medium according to claim 10, wherein
the four or more sections include a first section, a second section, a third section, and a fourth section, and
the designing the lengths of the four or more sections is designing a length of the first section, a length of the second section, a length of the third section, and a length of the fourth section.

13. An optical filter comprising:
two or more waveguides; and
four or more sections provided for the two or more waveguides,
wherein at least two or more modes of light propagate through the four or more sections.
